(19) United States
(12) Patent Application Publication
(10) Pub. No.: US 2009/0222446 A1
(43) Pub. Date: Sep. 3, 2009

(54) THREE-DIMENSIONAL OBJECT IDENTIFICATION THROUGH RESONANCE FREQUENCIES ANALYSIS

(76) Inventors: Emmanuel GOLDSCHMIDT, Haifa (IL); Alexander Zaslavsky, Haifa (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/040,964

(22) Filed: Mar. 3, 2008

(51) Int. Cl. G06F 7/06; G06F 17/30

(52) U.S. Cl. 707/6; 707/E17.017

(57) ABSTRACT

The present invention discloses a system and a method for identifying input images of three-dimensional objects using at least one mathematical method, which enables calculating the resonance frequencies (also known as the natural frequencies) of a three-dimensional object.

The system may enable analyzing three-dimensional input objects; and identifying the input object by comparing the signature of the input object with signatures of the known objects stored in at least one database.

### FIELD OF THE INVENTION

The present invention generally relates to the field of identifying three-dimensional objects. More particularly, the present invention relates to object identification using objects' signature comparison.

### BACKGROUND OF THE INVENTION

Identifying three-dimensional objects may be a cumbersome task, especially for objects with little or no geometric symmetry. Software applications usually compare input information with known information retrieved from databases to identify inputs. In the case of comparing images of three-dimensional objects, the system may require arranging the view perspective of the two compared objects, scaling other elements describing the objects in mathematical terms.

Patent application number US2004177089, incorporated by reference herein, discloses a system and method for retrieval of Computer Aided Design (CAD) referred to hereinafter as the “Computer Aided Design Method” drawings of objects from a database. This identification is carried out by creating a source code of the drawing and comparing the code to other source codes retrieved from a database. The source code is calculated by considering a two-dimensional projection of the three-dimensional drawing and identifying lines types describing the frame.

Patent application number US2004249809, incorporated by reference herein, discloses a system and a method for performing search on three-dimensional objects. The 3D shapes are created and serve as an input of a search system. A user-defined similarity criterion may be used, and search results may be interactively navigated and feedback received for modifying the accuracy of the search results. Search input can also be given by picking 3D models from a cluster map or by providing the orthographic views for the 3D model. This method shall be referred to hereinafter as the “Similarity Criterion Method”.

Patent application number US2006114252, incorporated by reference herein, discloses a method for retrieving shapes and drawings. This method allows identifying the pose at which the three-dimensional shape is positioned as well as methods for determining multiple, unique drawing descriptors for two-dimensional drawings, and for obtaining intermediate three-dimensional representations of two dimensional drawings as one way to determine the descriptor. Methods are also disclosed to provide for searching of two-dimensional drawings and three-dimensional shapes using user-defined input, which may be a drawing or sketch. The method enables the user to interactivity refine the search results. This method shall be referred to hereinafter the “Two-Dimensional Method”.

For physical objects, several physical properties depend upon the geometry of the object (as well as upon other features such as the size, the materials from which the objects is made, the density of matter and the like). One of these properties is the set of resonance frequencies (also known as the natural frequencies) of the object.

Resonance frequencies of objects are measured and/or calculated in association with a specific direction along which the vibrating source is directed and with boundary conditions (e.g. free object geometrical boundaries, fixed object end, etc).

Patent application number EP0906560, incorporated by reference herein, discloses a method and a device for determination of the geometrical dimensions of the object, through impact excitation and registration of resonance frequencies of natural modes of the object. The resonance frequency from at least one of the natural modes of the object is used, which resonance frequency is achieved by bringing the object in vibration by means of a stroking body, and substantially controlling the initiation of the motion of the stroking body and subsequent physical impact in time and space by motion of the object. This method shall be referred to hereinafter as the “Physical Impact Method”.

The above refers to determining of the dimensions of physical bodies by using physical vibrating of the body and measuring the consequential natural modes.

### SUMMARY OF THE INVENTION

The present invention discloses a system and a method for identifying geometrical input of three-dimensional objects using a mathematical method, for example, “the finite element method”, which enables calculating the resonance frequencies (also known as the natural frequencies) of a three-dimensional object.

According to some embodiments of the invention, the system may comprise an input object analyzer enabling to analyze three-dimensional input objects and output a signature for the object based on the object's resonance frequencies; and a search module associated with at least one database. The database may comprise signatures of known objects, where the search module may enable identifying the input object by comparing the signature of the input object with the signatures of the known objects.

According to some embodiments of the invention, the signature of an object may be a set of object resonance frequencies, calculated by using mathematical and numeric techniques such as, for example, the finite element method as known in the art.

According to some embodiments of the invention, the system may be a software application enabling to search the database for matching signatures and displaying of the resulting matching known object through a display unit enabling to display three-dimensional images.

According to some embodiments of the invention, the application may be a web application enabling a multiplicity of users to input three-dimensional objects and to search the database for matching objects. Additionally, the application may enable storing at least part of the input objects inserted by the users, whereby the database of known objects' signatures may be accumulated.

According to embodiments of the invention, a user may be required to input the image of the input object through a specific predefined format (or allow selecting one of predefined number of formats) such as, for example, three-dimensional images created in SolidWorks (by Solidworks Corp., Concord, Mass., USA), which is a software tool for designing three-dimension objects. The input object analyzer may then scale the input object image according to a predefined process, to calculate of the object's signature and compare it with known signatures from the database.

According to some embodiments of the invention, the method for creating a signature using the resonance frequencies of the objects may be integrated with other methods for identifying of a three-dimensional object that are known in the art.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 schematically illustrates a system for object-identification, according to some embodiments of the invention;

FIG. 2 is a flowchart, schematically illustrating a process for object-identification, according to some embodiments of the invention; and

FIG. 3 is a flowchart, schematically illustrating a process for creating the object signature based on three-dimensional object resonance frequencies analysis, according to some embodiments of the invention.

The drawings together with the description make apparent to those skilled in the art how the invention may be embodied in practice.

### DETAILED DESCRIPTIONS OF SOME EMBODIMENTS OF THE INVENTION

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, discloses a system and a method for identification of three-dimensional objects, which are computer readable three-dimensional geometrical forms referred to hereinafter as “objects”. The method and system may enable the identification of the geometrical objects by creating a mathematical signature defining each object, using a predefined object analysis algorithm(s).

According to some embodiments of the invention, the creation of the mathematical signature may be carried out by defining Finite Element Mesh (a method of discretization of a continuous domain into a set of discrete sub-domains known as elements) for the object, and calculating of an array of resonance frequencies associated with this mesh using the Finite Element Method.

The Finite Element Method as known in the art is an approximate method that allows one to calculate resonance frequencies of three-dimensional objects. These frequencies compose an encoded signature of the object. In order to improve the accuracy of the Finite Element Method, one usually refines the mesh. Thus, by using different meshes one often creates more than one array of frequencies and gets a matrix by which the signature of the object may be defined.

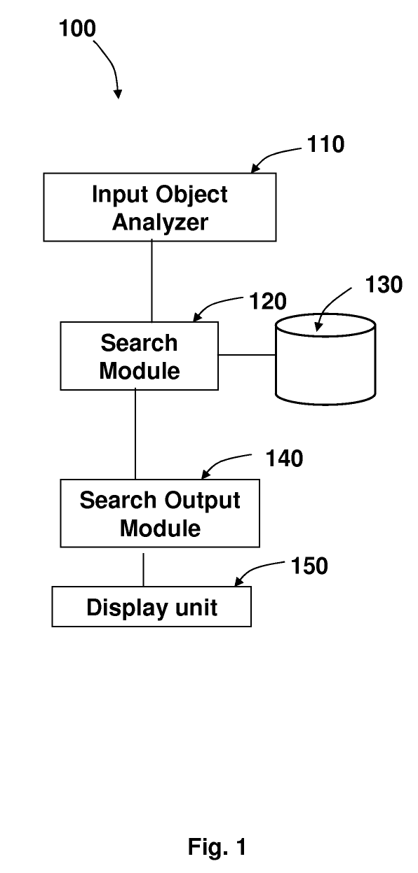

According to some embodiments of the invention, as illustrated in FIG. 1, the system may be a software application 100, which may comprise:
an input object analyzer 110 for analyzing three-dimensional input objects and output the object's signature resonance frequencies;
a search module 120 associated with at least one database 130, where the database may comprise signatures of known objects that may be compared with the input object's signature to find whether the input object resembles those in the database 130;
search output module 140 enabling to present the results of the search and associated information.

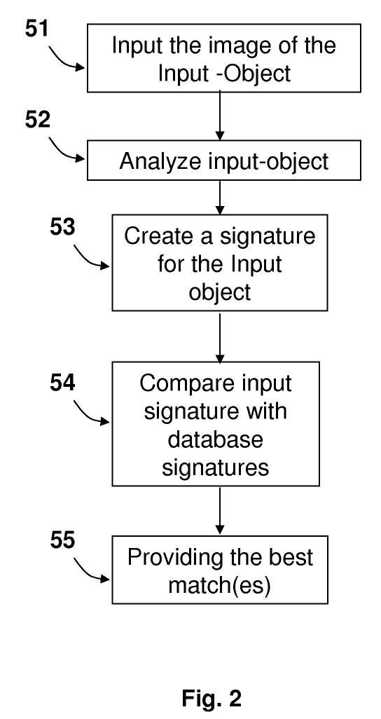

FIG. 2 is a flowchart, schematically illustrating a process for object-identification, according to some embodiments of the invention. The process may comprise the steps of:
inputting the image of the input object 51, where the input object analyzer 110 may position the object's image according to a predefined input format such as, for example, specific viewing angles from which the object is viewed and analyzed, and scaling the dimensions (meaning that, the application 100 may only enable reading specific predefined three-dimensional formats). The analyzer 110 may carry out a “preliminary processing” of the input data to prepare it, for example, according to predefined standards.
Analyzing input object 52, where the analyzer 110 enables creating a signature 53, which may comprise at least one set or array of the resonance frequencies of the object in at least one direction, where the signature may enable identifying the object.
Comparing the signature of the input object with known signatures 54, where the search module 120 may enable comparing the signature of the input object with known signatures of objects stored at the database 130.
Providing the best matching known object or objects (“best matches”) 55 according to predefined rules calculated by a predefined algorithm.

According to some embodiments of the invention, the application 100 may define “matching” or “semi-matching” known objects according to a predefined set of rules, for example by calculating a “distance parameter” determining the distance between the input object's signature and each one of the known object signatures (where the distance may be for example, the absolute value of the superposition-subtraction of the two objects' signatures). The best matching known object—the “best match” may be the one that has the smallest distance from the input object. The presentation of the results may also be set according to predefined rules, for example presenting the images of a predefined number of known objects with the smallest distance to the input object, where the presentation may be sorted according to a descending order.

According to some embodiments of the invention, at least one mathematical analysis method may be used to calculate the resonance frequencies constituting the signature of the object or a combination of several mathematical and numeric methods and techniques. For example, a method called “the finite element method” that enables calculating a set of resonance frequencies (also called natural frequencies).

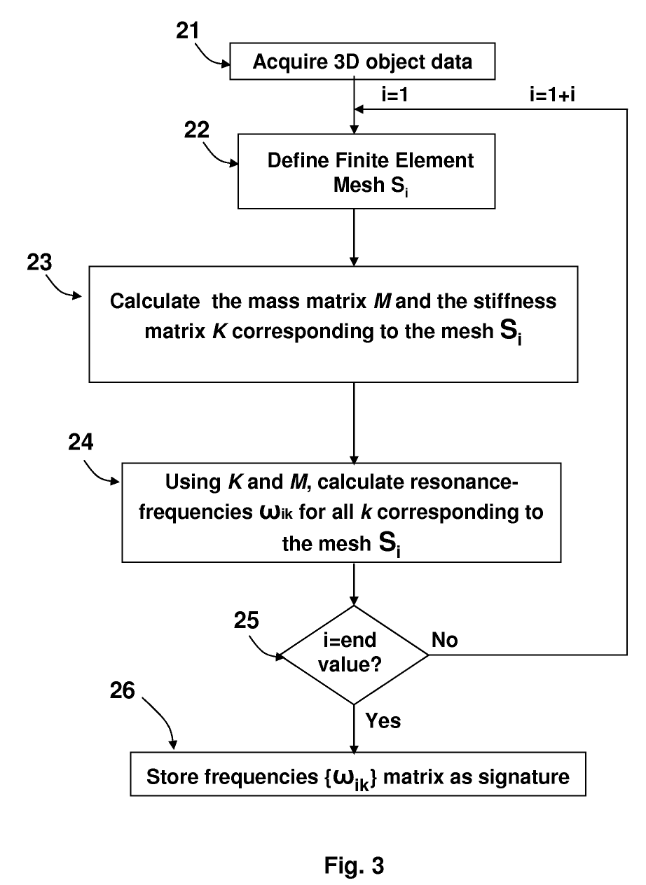

FIG. 3 is a flowchart, schematically illustrating a process of creating an object signature based on three-dimensional object resonance frequencies analysis, according to some embodiments of the invention. The process may comprise the steps of:
acquiring three-dimensional object data 21, where the input object analyzer 110 may retrieve the object's data and/or analyze the image of the object according to a predefined processing algorithm and/or predefined data format;
generating a finite element mesh Sᵢ for the solid 22. There exist many ways of automatic generation of meshes with different elements, for example, tetrahedron elements or hexahedron elements. The resulting number of nodes is denoted as n, 3n being the number of degrees of freedom;
assuming uniform elasticity modulus, constant material density and isotropic material, the 3n×3n stiffness matrix K and mass matrix M are calculated 23. These matrices are symmetric and M is positive semi-definite;

the resonance frequency estimates are calculated 24 as values of ω such that a nontrivial solution of the equation exists:

(K−ω²M)u=0,

u being a 3n nodal displacement vector. There exist 3n real, not necessarily distinct, solutions ωᵢ, which can be found, for example, by calculating the Cholesky decomposition of the mass matrix:

M=L·L^{T},

L being a 3n×3n matrix, and L^{T} the transpose matrix. Then the values of ωᵢ² are calculated as eigenvalues of the matrix L⁻¹K(L⁻¹)^{T}. Additional information on the implementation of the Finite Element Method, which is known to those skilled in the art, may be provided by Zienkiewicz et al. 2005. The Finite Element Method, Its Basics and Fundamentals, published by Elsevier, the disclosure of which is fully incorporated herein by reference;
steps 22-24 may be repeated 25 for each of the selected meshes according to predefined mesh selection mechanism;
storing the vector ω={ωᵢₖ} as the object's signature 26.

Additionally, the application 100 may also include a display unit 150 enabling to display the object and the finite element mesh of input as well as known objects from the database 130.

According to some embodiments of the invention, to identify an input object the search module 120 may compare at least part of the input object's frequencies with objects' signature frequencies.

According to some embodiments of the invention, a “matching signature” (meaning that the input object is identified as having substantially the same signature resonance frequencies as a known object) may be defined by the application 100 according to predefined “matching conditions”. The matching conditions may define the precision-level of match. For example, only the first several frequencies may be matched.

Additionally, the system may enable combining and integrating the resonance frequencies calculation method (for example, the Finite Elements Method) for three-dimensional object identification with other three-dimensional object identification techniques and methods such as, for example, with at least one of:
the Similarity Criterion Method;
the Computer Aided Design Method;
the Two-Dimensional Method;
the Physical Impact Method.

According to some embodiments of the invention, the application 100 may be a web application enabling a multiplicity of users to input objects and search for matching three-dimensional objects. Additionally, the application 100 may enable storing at least part of the input objects, whereby the database 130 of objects' signatures may be accumulated.

According to some embodiments of the invention, the signature of the input object may be added to the known signatures stored at the database 130 once identified as a “new object”, which was unknown before. The identification of a “new object” may be carried out by defining “new object” as any input object that has a distance that is smaller than a threshold distance between the input object and the known objects.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A method for identifying a three-dimensional input object, said method comprising the steps of:
creating a signature of said input object using at least one predefined mathematical process;
searching at least one database for matching objects by comparing the signature of the input object with known signatures of objects stored in said database;
wherein said mathematical process enables calculating resonance frequencies,
wherein said signature is at least one set of said frequencies of the object.

2. The method of claim 1 further comprising the step of scaling of the input object according to a predefined process before calculating the object signature.

3. The method of claim 1 further comprising the step of defining at least one finite element mesh for the input object.

4. The method of claim 3 further comprising the steps of:
calculating stiffness and mass matrices for the said mesh;
calculating at least one set of resonance frequencies associated with said mesh;
store frequencies as an array;
comparing the input object's signature with signatures of known objects; and
providing the best matching known objects identified in the comparison according to predefined rules.
wherein said at least one set of resonance frequencies is defined as the signature of said object.

5. The method of claim 4 wherein identifying the best matching objects is carried out by calculating the distances between the known objects and the input object.

6. The method of claim 5 wherein a predefined number of known objects that have the smallest distance parameters are presented in a descending order of distances.

7. The method of claim 1 further comprises the step of storing the signature of the input object.

8. The method of claim 7 further comprises the step of adding a new object to the known signatures that are stored, once the input object is identified as having a distance between the input object and the compared known objects that is smaller than a predefined threshold distance.

9. The method of claim 1 further comprises the steps of:
enabling a multiplicity of users to input objects and search for matching three-dimensional objects;
accumulating at least part of the users' input objects by storing at least some of the users input objects signatures, whereby a database of accumulated known objects' signatures is accumulated.

10. The method of claim 1 is integrated with at least one additional method for object identification.

11. The method of claim 10 wherein said additional method is at least one of:
the Similarity Criterion Method;
the Computer Aided design Method;
the Two-Dimensional Method;
the Physical Impact Method.

12. A system for identifying geometrical input objects, said system comprising:
an input object analyzer for analyzing three-dimensional input objects and output the object's signature resonance frequencies; and
a search module associated with at least one database, wherein said database comprises signatures of known objects, wherein said search module enables identifying of said input object by comparing the signature of said input object with the signatures of the known objects;
wherein said signature is calculated according to a mathematical method that enables calculating resonance frequencies, wherein said signature is at least one set of said frequencies of the object.

13. The system of claim 12 wherein said system is a software application further comprising a search output module enabling to output search results using said search output module.

14. The system of claim 13 further comprises a display unit that enables displaying the images of output objects that have a matching signature to the signature of the input object.

15. The system of claim 13 is a web application enabling a multiplicity of users to input three-dimensional objects and to search the database for matching objects by comparing the signature of the input objects with signatures of known objects stored in said database.

16. The system of claim 15 wherein said application enables storing at least part of the input objects inserted by the users, enabling the database of objects' signatures to be accumulated.

17. The system of claim 12 wherein said input object analyzer further enables scaling of the input object image according to a predefined process.

18. The system of claim 12 wherein said input object analyzer enables defining at least one finite element mesh of the input object.

19. The system of claim 12 wherein said input object analyzer enables creating a matrix constructed of arrays of resonance frequencies, wherein each array is associated with a different mesh for the said object;
wherein said matrix is defined as the signature of said object.

20. The system of claim 19 wherein said search module enables searching the database for a matching known signature by comparing at least part of the matrix of the input object to a corresponding matrix part of each object in the database.
